(19) United States
(12) Patent Application Publication
(10) Pub. No.: US 2023/0072925 A1
(43) Pub. Date: Mar. 9, 2023

(54) ARTIFICIAL INTELLIGENCE POWERED REDLINING OF TEXT DOCUMENTS

(71) Applicant: LexCheck Inc., New York, NY (US)

(72) Inventors: Michael Ludwig Ross, Brooklyn, NY (US); Alexander Dylan Sugar, Brooklyn, NY (US); Gurinder Singh Sangha, New York, NY (US)

(21) Appl. No.: 17/468,276

(22) Filed: Sep. 7, 2021

(51) Int. Cl. G06N 20/00

(52) U.S. Cl. CPC G06N 20/00

(57) ABSTRACT

An artificial intelligence (AI) system accesses training text documents and parses the training text documents to extract training edits. The AI system forms a set of training data that includes the training text documents and the training edits. The AI system trains an AI model based on at least the set of training data. The AI system may also use a reference model, a general model, and/or user input to generate the AI model. In some embodiments, the training text documents are associated with a type of transaction and the AI model is specific to the type of transaction. The AI system applies the AI model to a target text document to generate target edits. The AI system further modifies the target text document to include the target edits and transmits the modified target text document to a client device.

### BACKGROUND

### Field of Art

The described embodiments pertain in general to artificial intelligence, and in particular to artificial intelligence powered redlining of text documents.

### Description of the Related Art

Redlining is done on text documents such as contracts. It involves marking texts in documents to indicate that there have been additions, changes, rejections, approvals, or deletions. Currently, software tools are widely used for manual contract redlining. However, the currently available redlining tools typically are not customized to particular industry or customer needs. These tools are also insufficient for streamlining redlining for contracts involving multi-stage negotiations. Thus, improved technology for automatically redlining contracts is needed.

### SUMMARY

An artificial intelligence (AI) system generates an AI model and uses the AI model to redline text documents, such as contracts. The AI model may be specific to a type of transaction, such as non-disclosure agreement, intellectual property licensing, commercial transaction, and so on.

In various embodiments, the AI system generates the AI model based on training text documents. The AI system access the training text documents from a client device associated with a user. The AI system parses the training text documents to extract training edits made to the training text documents during the creation of the training text documents. The training text documents may be associated with the type of transaction. The AI system forms a training set that includes the training text documents and the training edits. The AI system trains the AI model based at least on the training set.

In some embodiments, the AI model includes various editing parameters and values of the editing parameters. The AI system uses the training set to determine the editing parameters and their values. An editing parameter defines a requirement for the type of transaction. The requirement may be a format requirement or a content requirement. The value of an editing parameter specifies whether the requirement is applicable. In other embodiments, the AI model is a model that is trained by using machine learning technologies. The AI model may include sub-models that the AI system generates based on the training set. For instance, the AI system classifies the training text documents into multiple categories. Each category corresponds to a different phase of the type of transaction. The AI system uses the training text documents in each category to generate a sub-model that is specific to the category. The AI system applies the AI model on a target text document to generate target edits for the target text document. The AI system modifies the target text document to include the target edits and transmits the modified target text document to a client device for user review.

The AI system can customize the AI model based on industry standards and/or customer preferences. For example, the AI system compares the AI model with a reference model and updates the AI model based on the comparison. As another example, the AI system generates the AI model by modifying a general model, which is applicable to various types of transaction, based on a customized training set of documents. As yet another example, the AI system receives a user input and generates the AI model based on the user input in addition to the training set. The AI system is capable of AI-powered adherence to industry standards and/or customized guidelines. Compared with conventionally available redlining tools, the AI system enables a faster and more user-friendly approach to redlining.

### BRIEF DESCRIPTION OF DRAWINGS

FIG. 1 is a block diagram illustrating an artificial intelligence (AI) environment including an AI system, according to one embodiment.

FIG. 2 is a block diagram of the AI application in FIG. 1, according to one embodiment.

FIG. 3 illustrates a user interface that allows users to interact with an AI model, according to one embodiment.

FIG. 4 illustrates a user interface that allows users to interact with AI generated edits, according to one embodiment.

FIG. 5 is a flow chart illustrating an AI powered redlining process, according to one embodiment.

FIG. 6 is a high-level block diagram illustrating a functional view of a typical computer system for use as the AI system of FIG. 1, according to one embodiment.

The figures depict various embodiments for purposes of illustration only. One skilled in the art will readily recognize from the following discussion that alternative embodiments of the structures and methods illustrated herein may be employed without departing from the principles of the embodiments described herein. Like reference numbers and designations in the various drawings indicate like elements.

### DETAILED DESCRIPTION

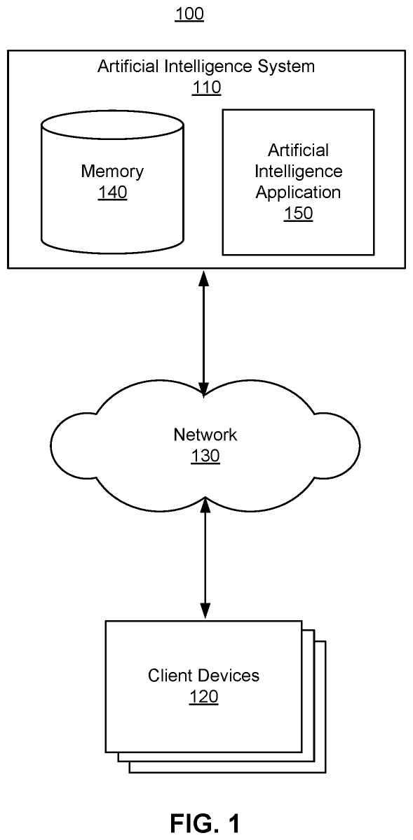

FIG. 1 is a block diagram illustrating an AI environment 100 including an AI system 110 according to one embodiment. The environment 100 further includes multiple client devices 120 connected to the AI system 110 via a network 130. Although the illustrated environment 100 contains only one AI system 110 coupled to multiple client devices 120, embodiments can have multiple AI systems and a singular client device.

The AI system 110 is a computer-based system utilized for AI powered redlining of text documents. The text documents are collected, gathered, or otherwise accessed from the multiple client devices 120 via the network 130. The AI system 110 can implement scalable software tools and hardware resources employed in redlining text documents from a wide variety of client devices. A redlining task is a computing operation for redlining a target text document. The AI system 110 can perform multiple redlining tasks in parallel. When it has computer resources (e.g., memory) available, the AI system 110 can pick a redlining task to perform from a plurality of tasks that are ready to be performed.

In the embodiment of FIG. 1, the AI system 110 includes a memory 140 and an AI application 150. The memory 140 stores data used and/or generated by the AI system 110 and provides access to data storage area(s). In some embodiments, the memory 140 includes random access memory (RAM), hard disk drive (HDD), solid-state drive (SSD), other forms of computer memory, or some combination thereof. In some embodiments, the memory 140 includes one or more memories providing relatively fast access to a relatively small data storage area and one or more other memories providing relatively slow access to a relatively large data storage area.

The AI application 150 is a software application supporting execution of redlining tasks. The AI application 150 generates AI models based on training text documents that include edits. For instance, the AI application 150 parses training text documents to extract the edits in the training text documents. The edits made to the training text documents in either manual or automated redlining processes are used by the AI application 150 as training edits for generating the AI models.

In some embodiments, the AI application 150 determines editing parameters from the training edits, e.g., by using natural language processing techniques. An editing parameter defines a content requirement or format requirement for a type of transaction. Examples of content requirements include a requirement of using or not using a term, a requirement of including or excluding a provision, a requirement of including or excluding a section, and so on. Examples of content requirements include a requirement for the order of provisions, a requirement for the order of sections, a requirement for font, a requirement for page layout, and so on. The AI application 150 generates an AI model that includes the editing parameters. In other embodiments, the AI application 150 trains a machine learning model by using the training text documents and training edits. The AI application 150 uses the training edits as ground truth edits of the training text documents. In one example, the AI application 150 inputs the training text documents into a neural network. The neural network outputs edits to the training text documents. The AI application 150 modifies the parameters of the neural network to minimize the error between the edits output from the neural network and the training edits.

In various embodiments, the AI application 150 generates transaction-specific AI models. A transaction-specific AI model is specific to a particular type of transaction and is generated based on training text documents associated with the particular type of transaction. A transaction-specific AI model may include phase-specific sub-models. A phase-specific sub-model is a model that is specific to a phase of the particular type of transaction. The AI application may identify multiple phases of the transaction from the training text documents and trains every phase-specific sub-model based on the training text documents associated with the corresponding phase.

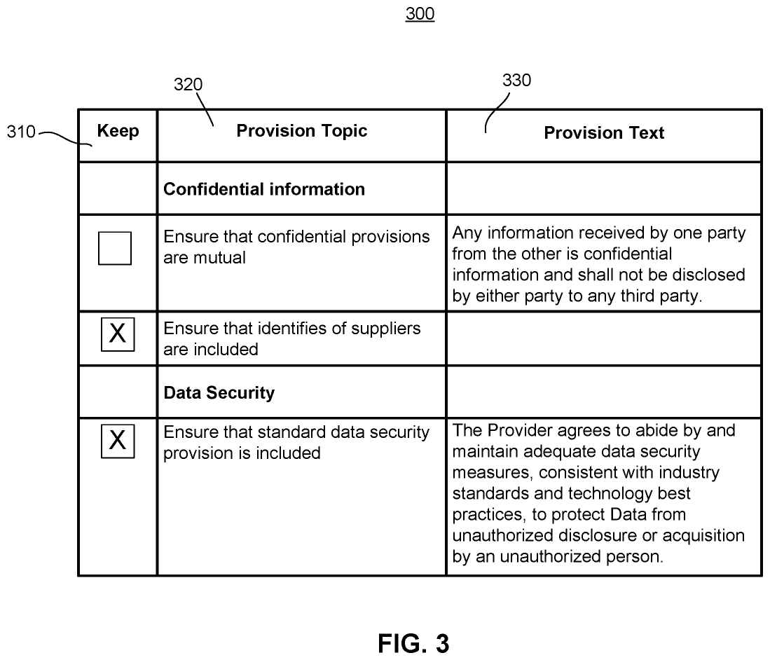

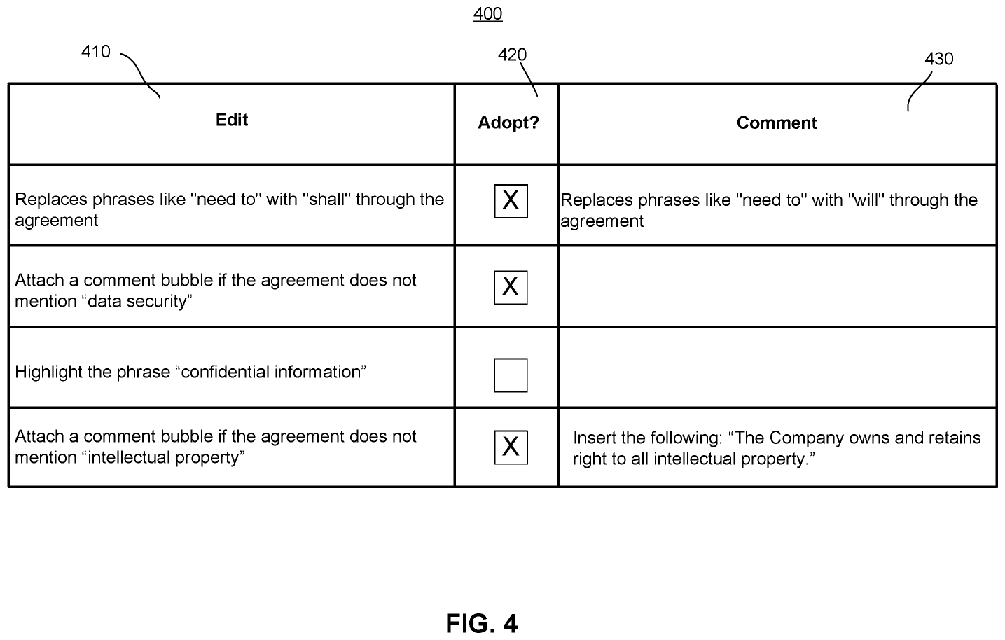

In some embodiments, the AI application 150 incorporates industry or customer standards into its AI models. The AI application 140 may start with a general model and generates the AI model by changing the general model based on the training text documents. Additionally or alternatively, the AI application 150 receives a reference model from a customer. The reference model may be a play book, for example. The AI application 150 may compare an AI model with the reference model and update the AI model based on the comparison. The AI application 150 may also support a user interface, such as the one shown in FIG. 3 or FIG. 4, that allows users to provide feedback to the AI model or edits to text documents that are generated by the AI model. The AI application 150 can change or retrain the AI model based on user inputs.

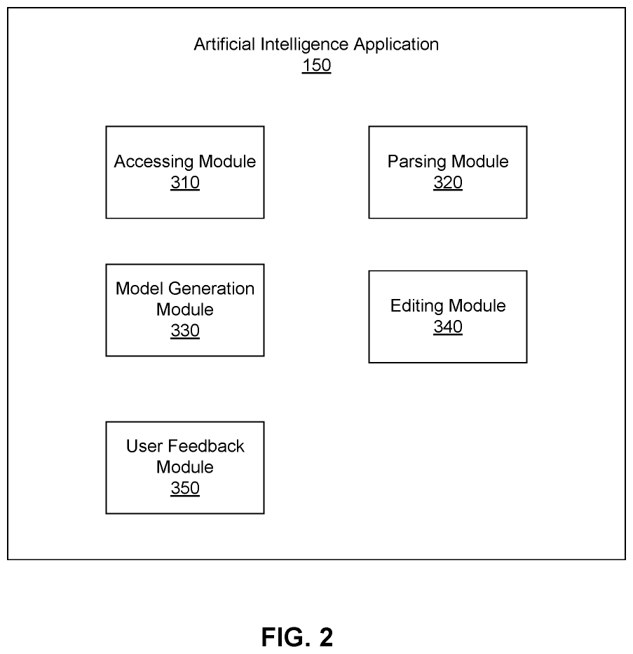

In some cases, the AI application 150 provides software that supports networked, or cloud-based, access to redlining tools and macros to multiple end users. As an example, the AI application 150 supports AI powered redlining in a manner of dashboard, web application, mobile application, etc. As another example, the AI application 150 allows users to share, browse and consume redlined text documents in a manner similar to a mobile application store or other cloud-based service. Some functions of the AI application 150 can be packaged and executed as a smaller scale and customizable analytic application (i.e., an app), for example, that can be accessed by other users of the AI system 110. In some cases, access to published redlining apps can be managed by the AI system 110, namely granting or revoking access, and thereby providing access control and security capabilities. The AI application 150 can perform functions associated with redlining apps such as creating, deploying, publishing, iterating, updating and the like. More details about the AI application 150 are described below in conjunction of FIG. 2.

The client devices 120 are one or more computing devices capable of receiving user input as well as transmitting and/or receiving data via the network 120. In one embodiment, a client device 120 is a conventional computer system, such as a desktop or a laptop computer. Alternatively, a client device 120 may be a device having computer functionality, such as a personal digital assistant (PDA), a mobile telephone, a smartphone, or another suitable device. A client device 120 is configured to communicate via the network 120. In one embodiment, a client device 120 executes an application allowing a user of the client device 120 to interact with the online system 140. For example, a client device 120 executes a browser application to enable interaction between the client device 120 and the online system 140 via the network 120. In another embodiment, a client device 120 interacts with the online system 140 through an application programming interface (API) running on a native operating system of the client device 120, such as IOS® or ANDROID™. A user can access, share, view, and manage text documents by using a client device 120. The user can also provide input to the AI application 150 through the client device 120.

The network 130 represents the communication pathways between the AI system 110 and the client devices 120. In one embodiment, the network 130 is the Internet and uses standard communications technologies and/or protocols. The data exchanged over the network 130 can be represented using technologies and/or formats including the hypertext markup language (HTML), the extensible markup language (XML), etc. In another embodiment, the entities can use custom and/or dedicated data communications technologies instead of, or in addition to, the ones described above.

FIG. 2 is a block diagram of the AI application 150 according to one embodiment. The AI application 150 facilitates AI-powered redlining of text documents. In the embodiment of FIG. 3, the AI application 150 includes an accessing module 310, a parsing module 320, a model generation module 330, an editing module 340, and a user feedback module 350. Those of skill in the art will recognize that other embodiments can have different and/or other components than the ones described here, and that the functionalities can be distributed among the components in a different manner.

The accessing module 310 accesses training text documents to be used for training an AI model. In various embodiments, the training text documents are associated with a type of transaction and are used to train an AI model that is specific to the type of transaction. In some embodiments, the accessing module 310 access a predetermined number of training text documents. The accessing module 310 may determine the predetermined number based on various factors, such as the type of transaction, the technique to be used for training the AI model, a value associated with the AI model, and so on. In some embodiments, the accessing module 310 queries a client device (e.g., a client device 120 in FIG. 1) for training text documents and receives the predetermined number of training text documents from the client device. In other embodiments, the accessing module 310 accesses a database of a client device and filter the text documents in the database to select the training text documents.

The parsing module 320 parses the training text documents to extract training edits from the training text documents. Examples of training edits include addition of words, deletion of words, movement of words, comments made in a training text document, and so on. In various embodiments, the parsing module 320 parses training text documents by using natural language processing techniques. In some embodiments, the parsing module 320 classifies the training text documents into a plurality of categories, each category corresponding to a different phase of the type of transaction and including one or more training text documents. The parsing module 320 provides the classification to the model generation module 330 for generating phase-specific models.

There can be multiple training text documents (e.g., a first training text document and a second training text document) for a same phase and those training text documents can be of different versions of a contract in the phase. The parsing module 320 may identify the latest version as the training text document for the phase. For instance, the parsing module 320 determines whether the first training text document of the training text documents is associated with a same phase of the type of transaction as a second training text document of the training text documents. In response to determining that the first training text document is associated with the same phase of the type of transaction as the second training text document, the parsing module 320 removes one of the first and the second training text documents from the training text documents.

The model generation module 330 generates an AI model based on the training text documents and the training edits. In various embodiments, the AI model is specific to the type of transaction that the training text documents are associated with. The AI model may include multiple sub-models. A sub-model is a model that is specific to a phase of the type of transaction. The multiple sub-models in the AI model are for different phases of the type of transaction. For example, the AI model includes a sub-model for term sheet, a sub-model for memorandum of understanding, and a sub-model for formal contract. The AI model, when applied on a target text document, redlines the target text documents. In some embodiments, the AI model includes various editing parameters. The model generation module 330 determines the editing parameters based on the training edits. An editing parameter specifies a requirement for target text documents. Examples of such a requirement include a requirement of using or not using a term, a requirement of including or excluding a provision, a requirement of including or excluding a section, a requirement for the order of provisions, a requirement for the order of sections, a requirement for font, a requirement for page layout, and so on.

In some embodiments, the model generation module 330 uses a reference model to generate the AI model. The reference model includes reference values of the editing parameters. The reference model may be a standard model or a model that has been generated and used for the type of transaction. In one example, the reference model is a playbook. The model generation module 330 may receive the reference model from the client device. The model generation module 330 determines whether the value of any editing parameter in the model conflicts with the reference value of the editing parameter in the reference model. In response to determining that the value of a particular editing parameter in the model conflicts with the reference value of the particular editing parameter in the reference model, the model generation module 330 resolves the conflict by selecting either the value of the particular editing parameter or the reference value of the particular editing parameter as a resolved value of the particular editing parameter.

In some embodiments, the model generation module 330 resolves the conflict by transmitting the value of the particular editing parameter and the reference value of the particular editing parameter to the client device. The client device presents the value of the particular editing parameter and the reference value of the particular editing parameter to a user in a user interface. The model generation module 330 receives the user's selection of the value of the particular editing parameter or the reference value of the particular editing parameter and uses the user's selection as the resolved value of the particular editing parameter. The model generation module 330 updates the AI model based on the resolved value of the particular editing parameter, the updated model to be used to generate edits for text documents associated with the type of transaction.

In some embodiments, the model generation module 330 receives a general model. The general model is applicable to multiple types of transaction, including the type of transaction of the AI model. The model generation module 330 generates the AI model by modifying the general model based on the set of training data. For instance, the model generation module 330 extracts editing parameters from the general model and combines the editing parameters from the general model with the editing parameters generated from the training text documents to generate the AI model.

In various embodiments, the model generation module 330 generates the AI model by using machine learning techniques. The model generation module 330 applies machine learning techniques to generate the AI model that when applied to target text documents outputs edits to the target text documents. As part of the generation of the AI model, the model generation module 330 forms a training set that includes the training text documents and the training edits. The model generation module 330 extracts feature values from the training set, the features being variables deemed potentially relevant to whether or not an edit should be made to target text documents. Specifically, the feature values extracted by the model generation module 330 include, e.g., attributes of the type of transaction, attributes of training text documents, attributes of training edits, and so on. An ordered list of the features is herein referred to as the feature vector. In one embodiment, the model generation module 330 applies dimensionality reduction (e.g., via linear discriminant analysis (LDA), principle component analysis (PCA), or the like) to reduce the amount of data in the feature vectors to a smaller, more representative set of data.

In some embodiments, the model generation module 330 uses supervised machine learning to train the AI model, with the feature vectors of the positive training set and the negative training set serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments.

An example of the AI model is a neural network. For instance, the AI system inputs the training set into a neural network and modifies the parameters of the neural network to minimize the error between the generated edits (i.e., edits to the training text documents that are generated by the neural network) and the ground truth edits (i.e., the training edits in the training set).

The editing module 340 applies the AI model on a text document to generate target edits for the text document. In embodiments where the AI model includes editing parameters, the editing module 340 applies the editing parameters to the AI model and generates the edits. In embodiments where the AI model is a machine learning model, the editing module 340 inputs the text document into the AI model. The AI model outputs the edits. The editing module 340 also redlines the text documents by modifying the text document to include the edits. The editing module 340 may further transmit the modified text document to the client device.

The user feedback module 350 receives user feedbacks and transmits the user feedbacks to the model generation module 330 for updating the AI model. In some embodiments, the user feedback module 350 supports a user interface that presents editing parameters of the AI model to users and allows the user to interact with the editing parameters. Examples of user interactions include, e.g., removing an editing parameter, adding an additional editing parameter, modifying the value of an editing parameter, and so on. The user feedback module 350 receives the user input and transmits the user input to the model generation module 330 for the model generation module 330 to update the AI model accordingly. The user feedback module 350 may also present conflicting values of an editing parameter for display in the user interface. The conflicting values of the editing parameter may include a value in the AI model and a value in a reference model. The user interface allows the user to select one of the conflicting values as a value of the editing parameter. The user feedback module 350 can transmit the value selected by the user to the model generation module 330 for updating the AI model.

Additionally or alternatively, the user feedback module 350 supports a user interface that presents text document edits that are generated by using the AI model (also referred to as “AI generate edits”). The user interface allows users to interact with the AI generated edits. For instance, the user interface allows a user to adopt or abandon an edit, make comments on an edit, or modify an edit. The user feedback module 350 receives the user interaction through the user interface and transmits the user interaction to the model generation module 330. The model generation module 330 may use the user interaction to modify the editing parameters in the AI model. In embodiments where the AI model is trained by using machine learning techniques, the user interaction can be used as new training data to further train the AI model so that the AI model can be continuously trained.

FIG. 3 illustrates a user interface 300 that allows users to interact with an AI model according to one embodiment. The user interface 300 presents editing parameters of the AI model to users. For purpose of illustration and simplicity, FIG. 3 shows three editing parameters, which specify requirements of including certain provisions in a contract. In other embodiments, the user interface 300 can show a different number of editing parameters. Also, the editing parameters may specify different requirements. The user interface 300 presents the three editing parameters in a table that includes three columns 310, 320, and 330. In other example, the user interface 300 may present the editing parameters in a different format.

The column 310 includes checkboxes for the editing parameters. A user is allowed to select a checkbox of an editing parameter to keep the editing parameter in the AI model. Similarly, a user may un-select a selected checkbox to remove the editing parameter from the AI model. The column 320 shows topics of the provisions for the editing parameters. The column 330 shows content of the provisional for the editing parameters. Also, the user interface classifies the editing parameters into two categories, confidential information and data security, based on the topics of the provisions. The provisional topics, provision text, and the classification help the user to understand the editing parameters so that the user can make informed decisions regarding whether to keep or remove an editing parameter.

FIG. 4 illustrates a user interface 400 that allows users to interact with AI generated edits according to one embodiment. The user interface 400 is in the form of a table including three columns 410, 420, and 430. In other embodiments, the user interface 400 may be in other forms. The column 410 shows edits to a text document that are generated by using an AI model. The column 420 includes checkboxes for the edits that a user can select to adopt the edit. Similarly, a user may un-select a selected checkbox to remove adoption of the edit. The column 430 includes input boxes for the edits. A user can make a comment on the edits by using the corresponding input box.

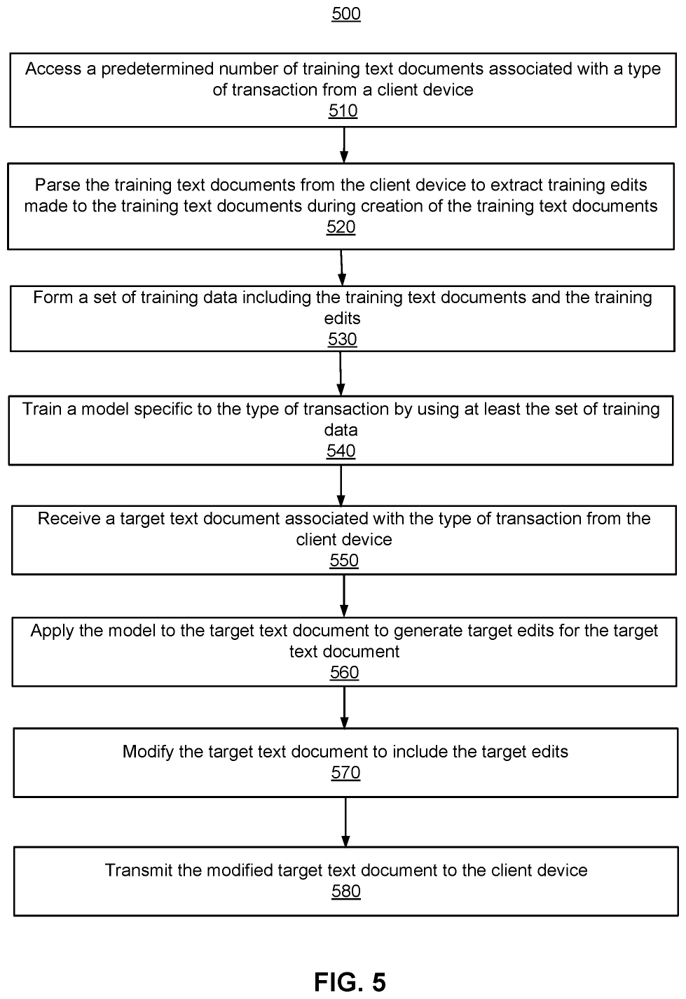

FIG. 5 is a flow chart illustrating an AI powered redlining process 500 according to one embodiment. In some embodiments, the process 500 is performed by the AI application 150, although some or all of the operations in the process 500 may be performed by other entities in other embodiments. In some embodiments, the operations in the process 500 are performed in a different order and can include different and/or additional steps.

The AI application 150 accesses 510 a predetermined number of training text documents associated with the type of transaction from a client device. In some embodiments, the AI application 150 queries the client device or a user for training text documents. The AI application 150 receives the predetermined number of training text documents from the client device in response to the query.

The AI application 150 parses 520 the training text documents from the client device to extract training edits made to the training text documents during creation of the training text documents. The AI application 150 may parse the training text documents using various natural language processing techniques.

In some embodiments, the AI application 150 determines whether a first training text document of the training text documents is associated with a same phase of the type of transaction as a second training text document of the training text documents. In response to determining that the first training text document is associated with the same phase of the type of transaction as the second training text document, the AI application 150 removes one of the first and the second training text documents from the training text documents. In some embodiments, the AI application 150 determines a first time stamp associated with the training edits extracted from the first training text document. The AI application 150 also determines a second time stamp associated with the training edits extracted from the second training text document. The AI application 150 then whether the first time stamp is earlier than the second time stamp. In response to determining that the first time stamp is earlier than the second time stamp, the AI application 150 removes the first training text document from the training text documents.

The AI application 150 forms 530 a set of training data including the training text documents and the training edits. The AI application 150 trains 540 a model specific to the type of transaction by using at least the set of training data. In some embodiments, the model includes a set of editing parameters and each editing parameter in the set is associated with a value.

In various embodiments, the AI application 150 receives a reference model for the type of transaction from the client device. The reference model includes reference values of the set of editing parameters. The AI application 150 determines whether the value of any editing parameter in the model conflicts with the reference value of the editing parameter in the reference model. In response to determining that the value of a particular editing parameter in the model conflicts with the reference value of the particular editing parameter in the reference model, the AI application 150 resolves the conflict by selecting either the value of the particular editing parameter or the reference value of the particular editing parameter as a resolved value of the particular editing parameter.

The AI application 150 may resolve the conflict based on user input. For instance, the AI application 150 transmits the value of the particular editing parameter and the reference value of the particular editing parameter to the client device. The client device is configured to present the value of the particular editing parameter and the reference value of the particular editing parameter to a user in a user interface. The AI application 150 receives, from the user interface, the user's selection of the value of the particular editing parameter or the reference value of the particular editing parameter. The AI application 150 uses the user's selection as the resolved value of the particular editing parameter. The AI application 150 updates the model based on the resolved value of the particular editing parameter. The updated model is to be used to generate edits for text documents associated with the type of transaction.

In some embodiments, the AI application 150 receives a general model applicable to a plurality of types of transaction. The AI application 150 the model specific to the type of transaction by modifying the general model based on the set of training data.

In other embodiments, the AI application 150 classifies the training text documents into a plurality of categories, each category corresponding to a different phase of the type of transaction and including one or more training text documents. The AI application 150 generates a plurality of sub-models. Each sub-model is specific to a different phase of the type of transaction and generated by using the one or more training text documents in the corresponding category and the edits extracted from the one or more training text documents.

The AI application 150 may receive, from the client device, a user input to an edit in the modified target text document. The AI application 150 updates the model based on the user input. In various embodiments where the AI application 150 trains the model by using a machine learning technique and the set of training data, the AI application 150 updates the edits based on the user input and re-trains the model by using the text document and the updated edits as new training data.

The AI application 150 receives 550 a target text document associated with the type of transaction from the client device. The AI application 150 applies 560 the model to the target text document to generate target edits for the target text document. The AI application 150 modifies 570 the target text document to include the target edits. The AI application 150 transmits 580 the modified target text document to the client device.

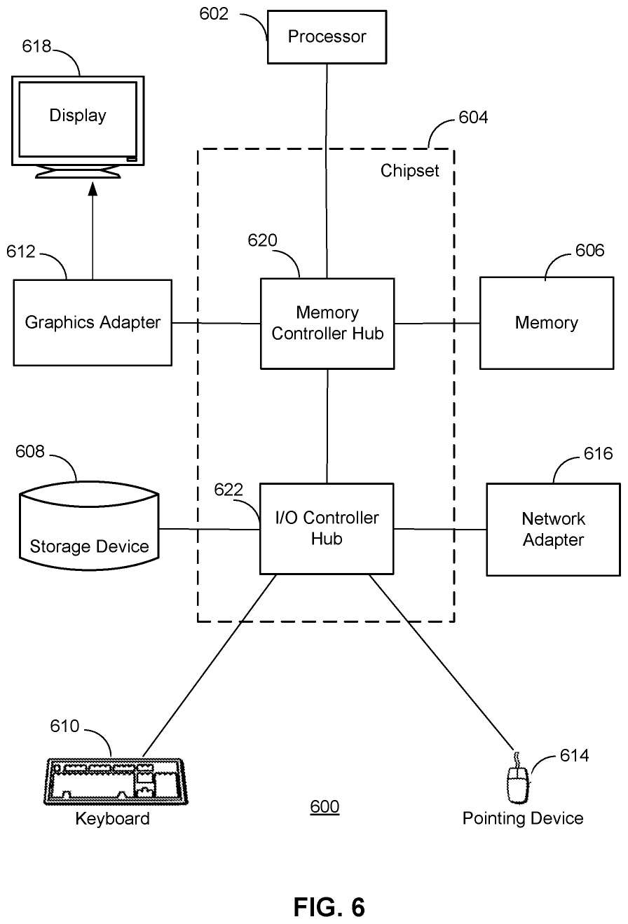

FIG. 6 is a high-level block diagram illustrating a functional view of a typical computer system 600 for use as the AI system 110 of FIG. 1 according to an embodiment. The illustrated computer system includes at least one processor 602 coupled to a chipset 604. The processor 602 can include multiple processor cores on the same die. The chipset 604 includes a memory controller hub 620 and an input/output (I/O) controller hub 622. A memory 606 and a graphics adapter 612 are coupled to the memory controller hub 620 and a display 618 is coupled to the graphics adapter 612. A storage device 608, keyboard 610, pointing device 614, and network adapter 616 may be coupled to the I/O controller hub 622. In some other embodiments, the computer system 600 may have additional, fewer, or different components and the components may be coupled differently. For example, embodiments of the computer system 600 may lack displays and/or keyboards. In addition, the computer system 600 may be instantiated as a rack-mounted blade server or as a cloud server instance in some embodiments.

The memory 606 holds instructions and data used by the processor 602. In some embodiments, the memory 606 is a random-access memory. The storage device 608 is a non-transitory computer-readable storage medium. The storage device 608 can be a HDD, SSD, or other types of non-transitory computer-readable storage medium. Data processed and analyzed by the machine learning server 110 can be stored in the memory 606 and/or the storage device 608.

The pointing device 614 may be a mouse, track ball, or other type of pointing device, and is used in combination with the keyboard 610 to input data into the computer system 600. The graphics adapter 612 displays images and other information on the display 618. In some embodiments, the display 618 includes a touch screen capability for receiving user input and selections. The network adapter 616 couples the computer system 600 to the network 160.

The computer system 600 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 608, loaded into the memory 606, and executed by the processor 602.

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

We claim:

1. A computer-implemented method, comprising:
accessing, by the artificial intelligence system, at least a predetermined number of training text documents associated with a type of transaction from a client device;
parsing, by the artificial intelligence system, the training text documents from the client device to extract training edits made to the training text documents during creation of the training text documents;
forming, by the artificial intelligence system, a set of training data including the training text documents and the training edits;
training, by the artificial intelligence system, a model specific to the type of transaction by using at least the set of training data;
receiving, by the artificial intelligence system, a target text document associated with the type of transaction from the client device;
applying, by the artificial intelligence system, the model to the target text document to generate target edits for the target text document;
modifying, by the artificial intelligence system, the target text document to include the target edits; and
transmitting, by the artificial intelligence system, the modified target text document to the client device.

2. The computer-implemented method of claim 1, wherein the model includes a set of editing parameters and each editing parameter in the set is associated with a value.

3. The computer-implemented method of claim 2, wherein training, by the artificial intelligence system, the model specific to the type of transaction by using at least the set of training data comprises:
receiving a reference model for the type of transaction from the client device, the reference model including reference values of the set of editing parameters;
determining whether the value of any editing parameter in the model conflicts with the reference value of the editing parameter in the reference model;
in response to determining that the value of a particular editing parameter in the model conflicts with the reference value of the particular editing parameter in the reference model, resolving the conflict by selecting either the value of the particular editing parameter or the reference value of the particular editing parameter as a resolved value of the particular editing parameter; and
updating the model based on the resolved value of the particular editing parameter, the updated model to be used to generate edits for text documents associated with the type of transaction.

4. The computer-implemented method of claim 3, wherein resolving the conflict by selecting either the value of the particular editing parameter or the reference value of the particular editing parameter as the resolved value of the particular editing parameter comprises:
transmitting the value of the particular editing parameter and the reference value of the particular editing parameter to the client device, the client device configured to present the value of the particular editing parameter and the reference value of the particular editing parameter to a user in a user interface;
receiving, from the user interface, the user's selection of the value of the particular editing parameter or the reference value of the particular editing parameter; and
using the user's selection as the resolved value of the particular editing parameter.

5. The computer-implemented method of claim 1, wherein training, by the artificial intelligence system, the model specific to the type of transaction by using at least the set of training data comprises:
receiving a general model applicable to a plurality of types of transaction; and
training the model specific to the type of transaction by modifying the general model based on the set of training data.

6. The computer-implemented method of claim 1, wherein parsing, by the artificial intelligence system, the training text documents received from the client device to extract the edits in the training text documents comprises:
classifying the training text documents into a plurality of categories, each category corresponding to a different phase of the type of transaction and including one or more training text documents,
wherein training, by the artificial intelligence system, the model specific to the type of transaction by using at least the set of training data comprises:
training a plurality of sub-models, each sub-model specific to a different phase of the type of transaction and generated by using the one or more training text documents in the corresponding category and the edits extracted from the one or more training text documents.

7. The computer-implemented method of claim 1, further comprising:
receiving, from the client device, a user input to an edit in the modified target text document; and
updating the model based on the user input.

8. The computer-implemented method of claim 7, wherein training, by the artificial intelligence system, the model for the type of transaction by using at least the set of training data comprises:
training the model by using a machine learning technique and the set of training data,
wherein updating the model based on the user input comprises:
updating the edits based on the user input; and
re-training the model by using the text document and the updated edits as new training data.

9. The computer-implemented method of claim 1, wherein parsing, by the artificial intelligence system, the training text documents received from the client device to extract the edits in the training text documents comprises:
determining whether a first training text document of the training text documents is associated with a same phase of the type of transaction as a second training text document of the training text documents; and
in response to determining that the first training text document is associated with the same phase of the type of transaction as the second training text document, removing one of the first and the second training text documents from the training text documents.

10. The computer-implemented method of claim 9, wherein in response to determining that the first training text document is associated with the same phase of the type of transaction as the second training text document, removing one of the first and the second training text documents from the training text documents comprises:
determining a first time stamp associated with the training edits extracted from the first training text document;
determining a second time stamp associated with the training edits extracted from the second training text document;
determining whether the first time stamp is earlier than the second time stamp; and
in response to determining that the first time stamp is earlier than the second time stamp, removing the first training text document from the training text documents.

11. A non-transitory computer-readable memory storing executable computer program instructions, the instructions when executed by a processor, cause the processor to:
access, by the artificial intelligence system, at least a predetermined number of training text documents associated with a type of transaction from a client device;
parse, by the artificial intelligence system, the training text documents from the client device to extract training edits made to the training text documents during creation of the training text documents;
form, by the artificial intelligence system, a set of training data including the training text documents and the training edits;
train, by the artificial intelligence system, a model specific to the type of transaction by using at least the set of training data;
receive, by the artificial intelligence system, a target text document associated with the type of transaction from the client device;
apply, by the artificial intelligence system, the model to the target text document to generate target edits for the target text document;
modify, by the artificial intelligence system, the target text document to include the target edits; and
transmit, by the artificial intelligence system, the modified target text document to the client device.

12. The non-transitory computer-readable memory of claim 11, wherein the model includes a set of editing parameters and each editing parameter in the set is associated with a value.

13. The non-transitory computer-readable memory of claim 12, wherein the instructions for training, by the artificial intelligence system, the model specific to the type of transaction by using at least the set of training data comprise instructions when executed by the processor, cause the processor to:
receive a reference model for the type of transaction from the client device, the reference model including reference values of the set of editing parameters;
determine whether the value of any editing parameter in the model conflicts with the reference value of the editing parameter in the reference model;
in response to determining that the value of a particular editing parameter in the model conflicts with the reference value of the particular editing parameter in the reference model, resolve the conflict by selecting either the value of the particular editing parameter or the reference value of the particular editing parameter as a resolved value of the particular editing parameter; and
update the model based on the resolved value of the particular editing parameter, the updated model to be used to generate edits for text documents associated with the type of transaction.

14. The non-transitory computer-readable memory of claim 11, wherein the instructions for training, by the artificial intelligence system, the model specific to the type of transaction by using at least the set of training data comprise instructions when executed by the processor, cause the processor to:
receive a general model applicable to a plurality of types of transaction; and
train the model specific to the type of transaction by modifying the general model based on the set of training data.

15. The non-transitory computer-readable memory of claim 11, wherein the instructions for parsing, by the artificial intelligence system, the training text documents received from the client device to extract the edits in the training text documents comprise instructions when executed by the processor, cause the processor to:
classify the training text documents into a plurality of categories, each category corresponding to a different phase of the type of transaction and including one or more training text documents,
wherein the instructions for training, by the artificial intelligence system, the model specific to the type of transaction by using at least the set of training data comprise instructions when executed by the processor, cause the processor to:
train a plurality of sub-models, each sub-model specific to a different phase of the type of transaction and generated by using the one or more training text documents in the corresponding category and the edits extracted from the one or more training text documents.

16. The non-transitory computer-readable memory of claim 11, wherein the instructions when executed by the processor, further cause the processor to:
receive, from the client device, a user input to an edit in the modified target text document; and
update the model based on the user input.

17. The non-transitory computer-readable memory of claim 11, wherein the instructions for parsing, by the artificial intelligence system, the training text documents received from the client device to extract the edits in the training text documents instructions when executed by the processor, cause the processor to:
determine whether a first training text document of the training text documents is associated with a same phase of the type of transaction as a second training text document of the training text documents; and
in response to determining that the first training text document is associated with the same phase of the type of transaction as the second training text document, remove one of the first and the second training text documents from the training text documents.

18. A computer system, comprising:
a computer processor for executing computer program instructions; and
a non-transitory computer-readable memory storing computer program instructions executable by the computer processor to perform operations comprising:
accessing, by the artificial intelligence system, at least a predetermined number of training text documents associated with the type of transaction from the client device in response to the query;
parsing, by the artificial intelligence system, the training text documents received from the client device to extract training edits made to the training text documents during creation of the training text documents;
forming, by the artificial intelligence system, a set of training data including the training text documents and the training edits;
training, by the artificial intelligence system, a model specific to the type of transaction by using at least the set of training data;
receiving, by the artificial intelligence system, a target text document associated with the type of transaction from the client device;
applying, by the artificial intelligence system, the model to the target text document to generate target edits for the target text document;
modifying, by the artificial intelligence system, the target text document to include the target edits; and
transmitting, by the artificial intelligence system, the modified target text document to the client device.

19. The computer system of claim 18, wherein the model includes a set of editing parameters and each editing parameter in the set is associated with a value, wherein training, by the artificial intelligence system, the model specific to the type of transaction by using at least the set of training data comprises:
receiving a reference model for the type of transaction from the client device, the reference model including reference values of the set of editing parameters;
determining whether the value of any editing parameter in the model conflicts with the reference value of the editing parameter in the reference model;
in response to determining that the value of a particular editing parameter in the model conflicts with the reference value of the particular editing parameter in the reference model, resolving the conflict by selecting either the value of the particular editing parameter or the reference value of the particular editing parameter as a resolved value of the particular editing parameter; and
updating the model based on the resolved value of the particular editing parameter, the updated model to be used to generate edits for text documents associated with the type of transaction.

20. The computer system of claim 18, wherein parsing, by the artificial intelligence system, the training text documents received from the client device to extract the edits in the training text documents comprises:
classifying the training text documents into a plurality of categories, each category corresponding to a different phase of the type of transaction and including one or more training text documents,
wherein training, by the artificial intelligence system, the model specific to the type of transaction by using at least the set of training data comprises:
training a plurality of sub-models, each sub-model specific to a different phase of the type of transaction and generated by using the one or more training text documents in the corresponding category and the edits extracted from the one or more training text documents.
